(19) United States
(12) Patent Application Publication
(10) Pub. No.: US 2022/0397763 A1
(43) Pub. Date: Dec. 15, 2022

(54) DUAL-REFLECTOR OPTICAL COMPONENT

(71) Applicant: Facebook Technologies, LLC, Menlo Park, CA (US)

(72) Inventors: Babak Amirsolaimani, Redmond, WA (US); Fenglin Peng, Redmond, WA (US); Ying Geng, Bellevue, WA (US); Jacques Gollier, Sammamish, WA (US); Brian Wheelwright, Sammamish, WA (US)

(21) Appl. No.: 17/471,161

(22) Filed: Sep. 10, 2021

Related U.S. Application Data
(60) Provisional application No. 63/210,966, filed on Jun. 15, 2021.
(60) Provisional application No. 63/230,378, filed on Aug. 6, 2021.

(51) Int. Cl. G02B 27/01; G02B 27/14; G02B 5/30

(52) U.S. Cl. CPC G02B 27/0172; G02B 27/144; G02B 5/3083; G02B 5/3025

(57) ABSTRACT

A folded-path optical component usable as an ocular lens in a near-eye display is disclosed. The folded-path optical component includes a cavity formed by a pair of spaced apart coaxial curved reflective polarizers, and a partial reflector in the cavity for splitting an impinging light beam to propagate along two optical paths ending at an exit pupil of the optical component. Each optical path includes a reflection from one of the reflective polarizers and a transmission through the other one of the reflective polarizers.

### REFERENCE TO RELATED APPLICATIONS

This application claims priority from a U.S. Provisional Patent Application No. 63/210,966 filed on Jun. 15, 2021, entitled “Dual Pancake Lens”, and from a U.S. Provisional Patent Application No. 63/230,378, filed on Aug. 6, 2021, entitled “Double Pancake Lens”, both of which being incorporated herein by reference in their entireties.

### TECHNICAL FIELD

The present disclosure relates to optical devices, and in particular to optical components having focusing or defocusing power, and visual display devices using such optical components.

### BACKGROUND

Visual displays are used to provide information to viewer(s) including still images, video, data, etc. Visual displays have applications in diverse fields including entertainment, education, engineering, science, professional training, advertising, to name just a few examples. Some visual displays, such as TV sets, display images to several users, and some visual display systems are intended for individual users. Visual displays are viewed either directly, or by means of special glasses.

An artificial reality system generally includes a near-eye display (e.g., a headset or a pair of glasses) configured to present content to a user. A near-eye display may display virtual objects or combine images of real objects with virtual objects, as in virtual reality (VR), augmented reality (AR), or mixed reality (MR) applications. For example, in an AR system, a user may view images of virtual objects (e.g., computer-generated images (CGIs)) superimposed onto surrounding environment. In some near-eye displays, each eye of the user views an image displayed on a miniature display panel and observed through an ocular lens for viewing the display panel from a short distance.

Compact and efficient display systems are desired for head-mounted displays. Because a display of HMD or NED is usually worn on the head of a user, a large, bulky, unbalanced, and/or heavy display device would be cumbersome and may be uncomfortable for the user to wear. Compact display devices require compact and efficient light sources, illuminators, display panels, ocular lenses, and so on.

### BRIEF DESCRIPTION OF THE DRAWINGS

Exemplary embodiments will now be described in conjunction with the drawings, in which:

FIG. 1 is a schematic view of an optical component of this disclosure usable as an ocular lens in a near-eye display device;

FIGS. 2A and 2B are raytrace diagrams of optical paths in an embodiment of the optical component of FIG. 1;

FIGS. 3A and 3B are raytrace diagrams of further embodiments of the optical component of FIG. 1;

FIG. 4 is a magnified side cross-sectional view of the symmetrical cavity of the optical component of FIGS. 2A and 2B;

FIG. 5 is a schematic view of a near-eye display including the optical component of FIGS. 1-4 used as an offset-to-angle component or an ocular lens of the near-eye display;

FIG. 6 is a top view of a near-eye display of this disclosure having a form factor of a pair of eyeglasses; and

FIG. 7 is a three-dimensional view of an example of a head-mounted display of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated.

A pancake lens may use a 50/50 mirror to fold an optical path of light within the pancake lens, resulting in a very compact overall configuration. On its folded optical path, the light encounters the 50/50 mirror twice. Upon the first encounter, the light propagates through the 50/50 mirror, and upon the second encounter, the light is reflected by the 50/50 mirror. Each time, 50% of light is lost, which leads to a total of at least 75% optical loss. In accordance with this disclosure, light reflected from the 50/50 mirror upon the first encounter can be re-used. To that end, the pancake lens may include optical element(s) that mirror the optical element(s) the light encounters along the optical path where the light propagates through the 50/50 mirror on the first encounter. The two optical paths provide a substantially same degree of focusing/defocusing of light, which is achieved by virtue of the symmetry of the two optical paths, although asymmetrical optical paths are also possible. The two optical paths provided in the optical component of this disclosure increase the light utilization of the pancake lens by 100%, to the total of about 50% optical throughput up from 25% optical throughput.

In accordance with the present disclosure, there is provided an optical component comprising a cavity formed by a pair of spaced apart coaxial curved reflective polarizers, and a partial reflector in the cavity. The partial reflector is configured for splitting an impinging light beam to propagate along two optical paths ending at an exit pupil of the optical component. Each optical path includes a reflection from one of the reflective polarizers and a transmission through the other one of the reflective polarizers.

The cavity may be substantially symmetrical, and the partial reflector may be equidistantly spaced from the reflective polarizers of the cavity. In some embodiments, the cavity is biconvex. The partial reflector may be flat. The cavity may further include a pair of quarter-wave plates (QWPs) on opposite sides of the partial reflector, e.g. a 50/50 reflector. The cavity may also include a pair of refractive optical elements on opposite sides of the partial reflector. Each refractive optical element may support one of the curved reflective polarizers on one side of the refractive optical element and one of the QWPs on the other side of the refractive optical element. The reflective polarizers may be linear reflective polarizers, for example. The QWPs may be supported by the partial reflector on opposite sides of the partial reflector. The optical component may also include other refractive elements disposed upstream and/or downstream of the cavity, to provide focusing/defocusing or image forming function.

In accordance with the present disclosure, there is provided a near-eye display (NED) comprising a display panel for providing an image in linear domain, and an optical component of this disclosure, for converting the image in linear domain into an image in angular domain at an eyebox of the NED.

In accordance with the present disclosure, there is further provided an offset-to-angle optical component comprising a substantially symmetrical cavity formed by a pair of spaced apart coaxial curved reflective polarizers, and a 50/50 partial reflector in the middle of the cavity, separating the cavity into substantially identical first and second portions. The reflective polarizers may be linear reflective polarizers, and each one of the first and second portions may include a quarter-wave plate.

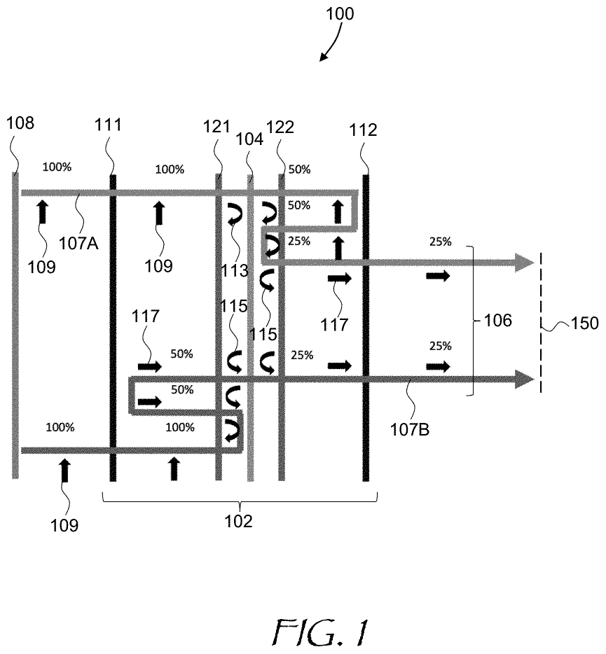

Referring now to FIG. 1, an optical element 100 can be used as an ocular lens in a near-eye display. The optical element 100 includes a cavity 102 formed by first 111 and second 112 reflective polarizers. A partial reflector 104 is disposed in the cavity 102. The partial reflector 104 may be equidistantly spaced from the first 111 and second 112 reflective polarizers of the cavity 102. The partial reflector 104 splits an impinging light beam 106 to propagate along first 107A and second 107B optical paths. The first 107A and second 107B optical paths end at an exit pupil 150 of the optical component 100. Each one of the first 107A and second 107B optical paths includes a reflection from one of the first 111 and second 102 reflective polarizers, and a transmission through the other one of the first 111 and second 102 reflective polarizers, to be explained in more detail further below.

In the embodiment shown in FIG. 1, the cavity 102 is substantially symmetrical. In some embodiments, the cavity 102 may be asymmetric, with nonetheless substantially same optical (i.e. focusing/defocusing) power of the first 107A and second 107B optical paths. In asymmetric cavities, the partial reflector 104 may be not flat, and may be not equidistant from the first 111 and second 112 reflective polarizers.

The first 111 and second 112 reflective polarizers may be linear reflective polarizers. The cavity 102 may further include first 121 and second 122 quarter-wave plates (QWPs) on opposite sides of the partial reflector 104, i.e. with the partial reflector 104 disposed between the first 121 and second 122 QWPs in the cavity 102. The first 121 and second 122 QWPs may be supported by the partial reflector 104, may be spaced apart from the partial reflector 104, and/or may be supported by some other optical element(s) in various embodiments.

In operation, light 106 emitted by a display panel 108 is linearly polarized in plane of FIG. 1, as indicated by vertical arrows 109. This polarization direction is referred below as vertical polarization. The light 106 propagates along first 107A and second 107B optical paths, which are parallel paths in the sense that the light 106 propagates along both of them at the same time and not sequentially. The first 107A and second 107B optical paths are shown offset from one another for clarity.

On the first optical path 107A, the light 106 propagates through the first reflective polarizer 111 oriented to propagate vertically polarized light, and through the first QWP 121, becoming right-circular polarized as indicated by arrows 113 curved to the right. Then, the light 106 propagates through the partial reflector 104 and the second QWP 122, becoming vertically polarized again. The propagation through the 50/50 reflector incurs 50% optical losses. At the vertical polarization state, the second reflective polarizer 112 reflects the light 106 to propagate back through the second QWP 122. At this point, the light 106 is right-circular polarized again. Then, the light 106 is reflected from the partial reflector 104, incurring another 50% optical loss, to the total of 75% optical loss. Also upon reflection, the handedness of the circularly polarized light 106 reverses to left-handed polarization indicated by arrows 115 curved to the left. The left-circular polarized light 106 propagates again through the second QWP 122, becoming polarized perpendicular to the plane of FIG. 1, as indicated with horizontal arrows 117. Hereinforth, such polarization direction will be referred to as horizontal polarization. The horizontally polarized light 106 propagates through the second reflective polarizer 112.

On the second optical path 107B, the light 106 propagates through the first reflective polarizer 111 oriented to propagate vertically polarized light, and the first QWP 121, becoming right-circular polarized. Then, the light 106 is reflected by the partial reflector 104 and becomes left-circular polarized. The left-circular polarized light 106 propagates again through the first QWP 121, becoming horizontally polarized. The reflection by the 50/50 reflector incurs 50% optical losses. In the horizontal polarization state, the first reflective polarizer 111 reflects the light 106 to propagate back through the first QWP 121. At this point, the light 106 is left-circular polarized again. Then, the light 106 propagates through the partial reflector 104, incurring another 50% optical loss, to the total of 75% optical loss. The left-circular polarized light 106 propagates through the second QWP 122, becoming horizontally polarized as indicated. The horizontally polarized light 106 propagates through the second reflective polarizer 112. The two optical path add up to 50% of the incoming light, which is 2× larger than in a regular pancake lens. It is to be noted that the vertical and horizontal orientations of the polarization are only meant as a non-limiting example. Furthermore, even though the first 111 and second 112 reflective polarizers are illustrated as linear reflective polarizers having mutually perpendicular orientation of the transmission axes, configurations with other types of polarizers and/or other orientations of transmission axes of linear reflective polarizers are also possible. For example, the transmission axes of the first 111 and second 112 reflective polarizers may be parallel to one another, with orientations of the first 121 and/or second 122 QWP changed accordingly to provide the first 107A and second 107B optical paths.

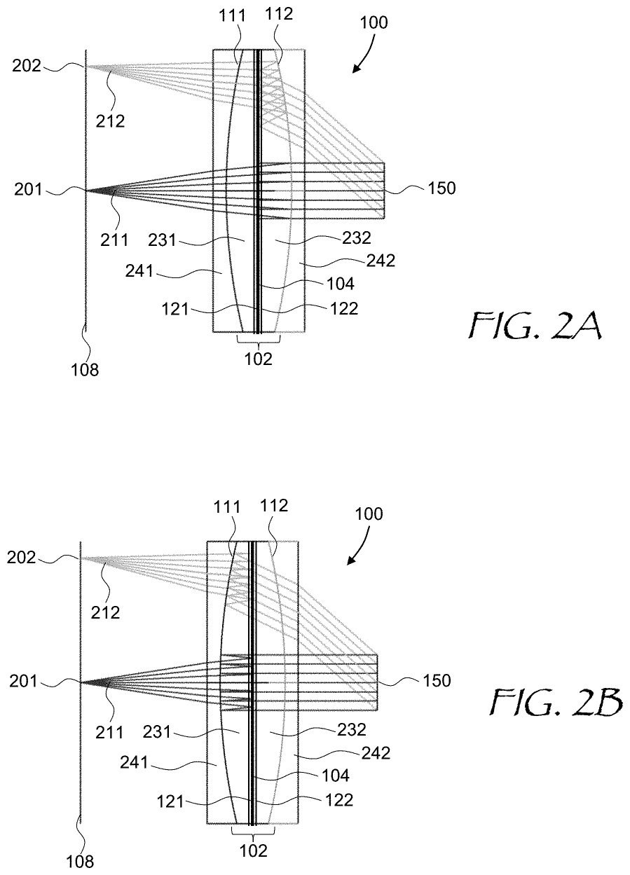

For the optical component 100 to have optical power, i.e. focusing or defocusing power, the first 111 and second 112 reflective polarizers may be curved. Referring to FIGS. 2A and 2B for a non-limiting example, the first 111 and second 112 reflective polarizers are curved outwards and disposed coaxially, such that the cavity 102 is biconvex. The first optical path 107A is illustrated in FIG. 2A, and the second optical path 107B is illustrated in FIG. 2B. On each of these Figures, the optical path is illustrated for an on-axis light beam 211 emitted by a first pixel 201 of the display panel 108, and for an off-axis light beam 212 emitted by a second pixel 202 of the display panel 108.

In the embodiment of FIGS. 2A and 2B, the cavity 102 includes a pair of refractive optical elements 231, 232 on opposite sides of the partial reflector 104. The refractive optical elements 231, 232 are symmetrical plano-convex singlet lenses, with their outer surfaces supporting the first 111 and second 112 reflective polarizers. The QWPs 121, 122 may be supported by the partial reflector 104, and/or may be disposed on flat surfaces of the plano-convex singlet lenses 231, 232.

The cavity 102 may be substantially symmetrical. Herein, the term “substantially” means that the cavity 102 may include symmetrically disposed elements having identical refractive optical elements 231, 232 as designed, but manufactured to regular optomechanical tolerances such that the shapes may be slightly different, which helps the reduction of unwanted optical interference at the exit pupil 150 between portions of the light 106 propagating along the first 107A and second 107B optical paths. The cavity 102 is biconvex in this example, and the partial reflector 104 is a flat partial reflector, e.g. a 50/50 reflector which reflects the same amount of light as it transmits; that is, the optical energy per unit time of the transmitted and reflected light is the same.

The substantially symmetrical cavity 102 may be formed by the pair of spaced apart coaxial curved first 111 and second 112 reflective polarizers, e.g. the linear reflective polarizers. The partial reflector 104 may be disposed in the middle of the cavity 102, separating the cavity 102 into two substantially identical portions, each portion including one of the QWPs 121, 122 and, in the embodiment shown in FIGS. 2A and 2B, one of the refractive optical elements 231, 232.

The optical component 100 may further include a first refractive optical element 241 upstream of the cavity 102, and a second refractive optical element 242 downstream of the cavity 102. Both the first refractive optical element 241 and the second refractive optical element 242 are external to the cavity 102. The first 241 and second 242 refractive optical elements of FIGS. 2A and 2B are plano-concave singlet lenses with the concave radiae matched to the convex radiae of the corresponding refractive optical elements 231, 232. It is noted that the first 241 and second 242 external refractive optical elements need not be symmetrical w.r.t. each other, i.e. they may be different optical elements, or one or both of them may be omitted altogether.

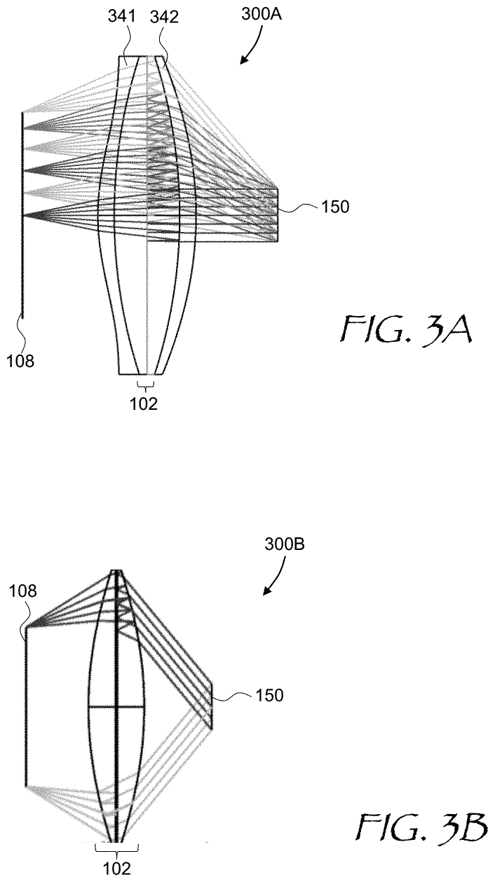

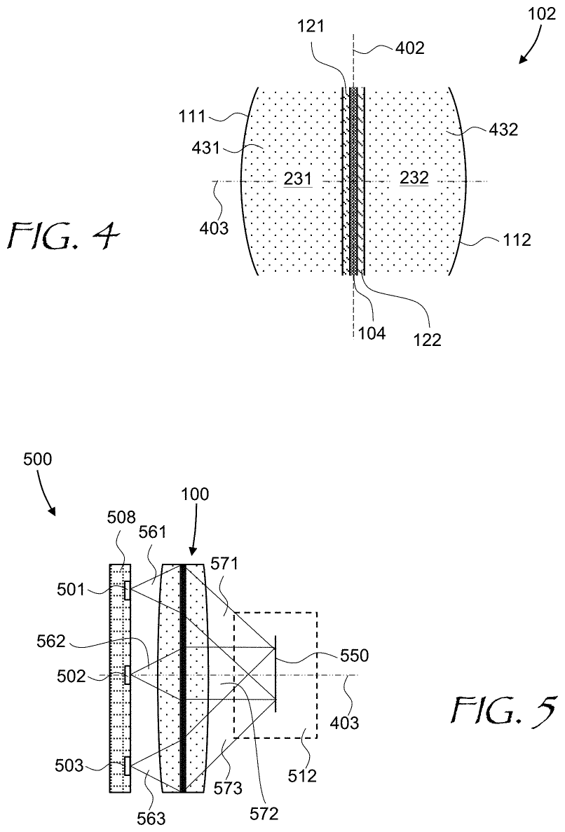

Optical component configurations with and without external refractive elements are illustrated in FIGS. 3A and 3B. Referring to FIG. 3A, an optical component 300A is a variant of the optical component 100 of FIGS. 1, 2A, and 2B, and includes similar elements pertaining to the cavity 102. The optical component 300A of FIG. 3A further includes a first external refractive optical element 341 of an aspheric meniscus shape, and a second external refractive optical element 342 of a spherical meniscus shape. In FIG. 3B, an optical component 300B is a variant of the optical component 100 of FIGS. 1, 2A, and 2B, and includes similar elements pertaining to the cavity 102. The optical component 300B lacks any external lens elements, all focusing being performed by the optical elements in the cavity 102.

Turning to FIG. 4, the cavity 102 is shown in greater detail. The cavity 102 is substantially symmetric about a symmetry plane 402. The cavity 102 is biconvex, with the reflective polarizers 111 and 112 outlining the biconvex shape and having curved surfaces rotationally symmetric about an optical axis 403 of the optical component 100. The partial reflector 104 is a flat 50/50 reflector disposed in the middle of the cavity 102, as measured along the optical axis 403. The partial reflector 104 is disposed in the symmetry plane 402. Thus, the symmetry plane 402 dissects the cavity 102 into two halves 431 and 432 of substantially same size and shape. The cavity 102 includes the pair of refractive elements 231 and 232 on the opposite sides of the partial reflector 104. Each one of the refractive optical elements 231, 232 supports one of the curved reflective polarizers 111, 112 on one side of the refractive optical element 231, 232, and one of the QWPs 121, 122 on the other side of the refractive optical element 231, 232. Put it differently, each one of the halves 431 and 432 includes one of the refractive optical elements 231, 232 supporting one of the curved reflective polarizers 111, 112 on one side and one of the QWPs 121, 122 on the other side.

Referring to FIG. 5, a near-eye display (NED) 500 includes a display panel 508 optically coupled to the optical component 100 of FIGS. 1 and 2A, 2B, or any variant of it considered herein. The display panel 508 is configured to provide an image in linear domain, that is, an image where individual pixels of the image are represented by row and column numbers of individual pixels of the display panel 508. Three such display panel pixels are shown in FIG. 5, a first pixel 501, a second pixel 502, and a third pixel 503. The second pixel 502 is an on-axis pixel, i.e. the second pixel 502 is disposed on the optical axis 403 of the optical component 100, while the first 501 and third 503 pixels are off-axis pixels disposed away from the optical axis 403.

The optical component 100 is configured to convert the image in linear domain into an image in angular domain at an eyebox 512 of the NED 500 for direct observation by a user's eye, not shown. Herein, the term “image in angular domain” refers to an image where individual pixels of the image are represented by an angle of a collimated optical beam at the eyebox 512. For example, the first pixel 501 emits a first diverging cone of light 561 that is collimated by the optical component 100 into a first collimated light beam 571 having an oblique angle of incidence at an exit pupil 550 of the NED 500 disposed in the eyebox 512. The second pixel 502 emits a second diverging cone of light 562 that is collimated by the optical component 100 into a second collimated light beam 572 having a zero (or normal) angle of incidence at the exit pupil 550. Finally, the third pixel 503 emits a third diverging cone of light 563 that is collimated by the optical component 100 into a third collimated light beam 573 having an oblique angle of incidence at the exit pupil 550, of an opposite sign as the first collimated light beam 571. In other words, the optical component 100 operates as an offset-to-angle element converting an offset of a diverging beam of light upstream of the optical component 100 into an angle of a collimated beam of light downstream of the optical component 100.

The optical component 100 of the NED 500 includes the cavity 102 (e.g. FIG. 1) formed by a pair of spaced apart coaxial curved reflective polarizers 111, 112, and a partial reflector 104 in the cavity 102 equidistantly spaced from the reflective polarizers 111, 112, for splitting the impinging light beam 106 to propagate along two optical paths 107A, 107B ending at the exit pupil 550 in the eyebox 512 (FIG. 5). Each optical path 107A, 107B (FIG. 1) includes a reflection from one of the reflective polarizers 111, 112 and a transmission through the other one of the reflective polarizers 111, 112.

To avoid doubling of the image in angular domain due to misalignment of the first 107A and second 107B optical paths of optical component 100 (FIG. 1), the first 111 and second 112 reflective polarizers and/or their supporting optics may need to be actively aligned relative to each other. Referring back to FIG. 4 for a non-limiting illustrative example, the left-side refractive optical element 231 supporting the first reflective polarizer 111 may be bonded to the left QWP 121 and the partial reflector 104, while the right-side refractive optical element 232 may be held separately, with the right QWP 122 optionally laminated or bonded. A thin liquid epoxy layer may be provided between these two subassemblies. The alignment between the subassemblies may be actively monitored, e.g. by using a camera imaging through the first 111 and second 112 reflective polarizers, or with an optical interferometer. The subassemblies may be tip/tilted relative to each other until the optical paths exactly match, as judged by an interference pattern and/or a test image detected by the camera. When this condition is met, the epoxy is cured with UV light, fixing the relative angle between the two subassemblies at positions that preclude double image formation.

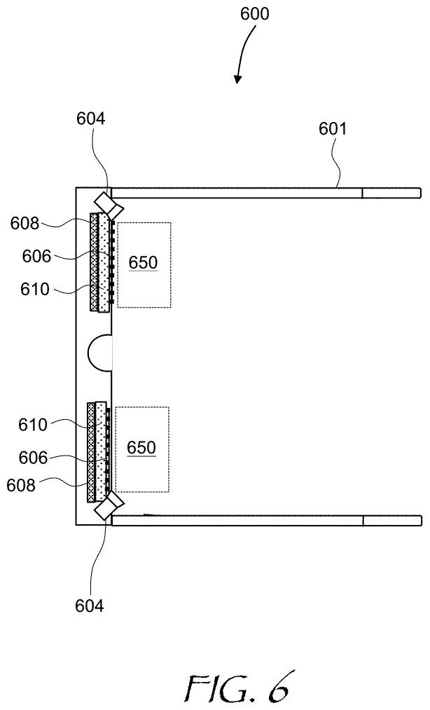

Referring now to FIG. 6, a near-eye display 600 includes a frame 601 having a form factor of a pair of eyeglasses. The frame 601 supports, for each eye: an electronic display panel 608, an ocular lens 610 optically coupled to the electronic display panel 608, an eye-tracking camera 604, and a plurality of illuminators 606. The ocular lens 610 may include any of the optical elements disclosed herein, e.g. the optical element 100 of FIGS. 1 and 2A, 2B, the optical element 300A of FIG. 3A, and the optical element 300B of FIG. 3B. The illuminators 606 may be supported by the ocular lens 610 for illuminating an eyebox 650. The electronic display panel 608 provides an image in linear domain that is converted by the ocular lens 610 into an image in angular domain for observation by a user's eye at an eyebox 650.

The purpose of the eye-tracking cameras 604 is to determine position and/or orientation of both eyes of the user. Once the position and orientation of the user's eyes are known, a gaze convergence distance and direction may be determined. The imagery displayed by the display panels 608 may be adjusted dynamically to account for the user's gaze, for a better fidelity of immersion of the user into the displayed augmented reality scenery, and/or to provide specific functions of interaction with the augmented reality. The focal length of the ocular lenses 610 may be tuned to lessen vergence-accommodation conflict, reducing tiredness and headache of a user of the near-eye display 600. In operation, the illuminators 606 illuminate the eyes at the corresponding eyeboxes 650, to enable the eye-tracking cameras 604 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with illuminating light, the latter may be made invisible to the user. For example, infrared light may be used to illuminate the eyeboxes 650.

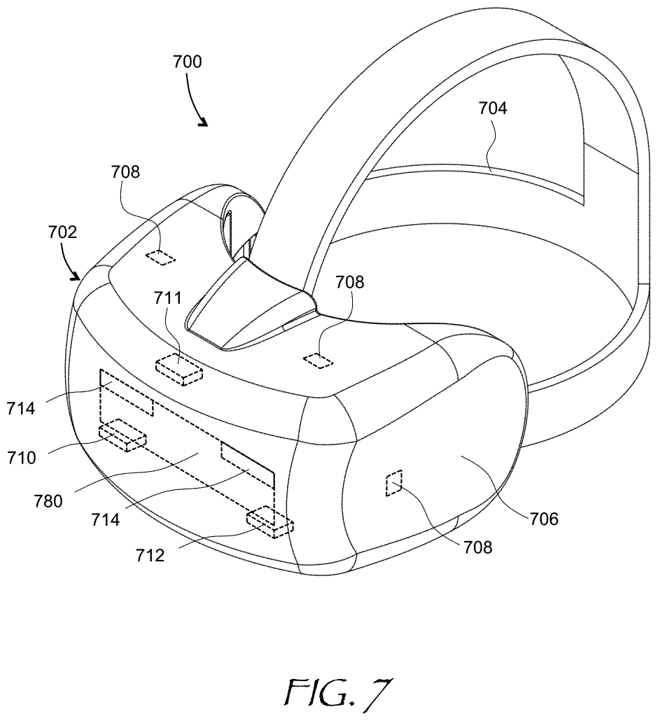

Turning to FIG. 7, an HMD 700 is an example of an AR/VR wearable display system which encloses the user's face, for a greater degree of immersion into the AR/VR environment. The function of the HMD 700 may be to generate the entirely virtual 3D imagery. The HMD 700 may include a front body 702 and a band 704. The front body 702 is configured for placement in front of eyes of a user in a reliable and comfortable manner, and the band 704 may be stretched to secure the front body 702 on the user's head. A display system 780 may be disposed in the front body 2102 for presenting AR/VR imagery to the user. The display system 780 may include any of the optical elements disclosed herein, e.g. the optical element 100 of FIGS. 1 and 2A, 2B, the optical element 300A of FIG. 3A, and the optical element 300B of FIG. 3B, and may include a pair of NEDs 500 of FIG. 5. Sides 706 of the front body 702 may be opaque or transparent.

In some embodiments, the front body 702 includes locators 708 and an inertial measurement unit (IMU) 710 for tracking acceleration of the HMD 700, and position sensors 712 for tracking position of the HMD 700. The IMU 710 is an electronic device that generates data indicating a position of the HMD 700 based on measurement signals received from one or more of position sensors 712, which generate one or more measurement signals in response to motion of the HMD 700. Examples of position sensors 712 include: one or more accelerometers, one or more gyroscopes, one or more magnetometers, another suitable type of sensor that detects motion, a type of sensor used for error correction of the IMU 710, or some combination thereof. The position sensors 712 may be located external to the IMU 710, internal to the IMU 710, or some combination thereof.

The locators 708 are traced by an external imaging device of a virtual reality system, such that the virtual reality system can track the location and orientation of the entire HMD 700. Information generated by the IMU 710 and the position sensors 712 may be compared with the position and orientation obtained by tracking the locators 708, for improved tracking accuracy of position and orientation of the HMD 700. Accurate position and orientation is important for presenting appropriate virtual scenery to the user as the latter moves and turns in 3D space.

The HMD 700 may further include a depth camera assembly (DCA) 711, which captures data describing depth information of a local area surrounding some or all of the HMD 700. The depth information may be compared with the information from the IMU 10, for better accuracy of determination of position and orientation of the HMD 700 in 3D space.

The HMD 700 may further include an eye tracking system 714 for determining orientation and position of user's eyes in real time. The obtained position and orientation of the eyes also allows the HMD 700 to determine the gaze direction of the user and to adjust the image generated by the display system 780 accordingly. In one embodiment, the vergence, that is, the convergence angle of the user's eyes gaze, is determined. The determined gaze direction and vergence angle may be used to adjust focal length of lenses of the display system 780 to reduce the vergence-accommodation conflict. The direction and vergence may also be used for real-time compensation of visual artifacts dependent on the angle of view and eye position. Furthermore, the determined vergence and gaze angles may be used for interaction with the user, highlighting objects, bringing objects to the foreground, creating additional objects or pointers, etc. An audio system may also be provided including e.g. a set of small speakers built into the front body 702.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An optical component comprising:
a cavity formed by a pair of spaced apart coaxial curved reflective polarizers; and
a partial reflector in the cavity, for splitting an impinging light beam to propagate along two optical paths ending at an exit pupil of the optical component, each optical path including a reflection from one of the reflective polarizers and a transmission through the other one of the reflective polarizers.

2. The optical component of claim 1, wherein the cavity is substantially symmetrical, and wherein the partial reflector is equidistantly spaced from the reflective polarizers of the cavity.

3. The optical component of claim 2, wherein the cavity is biconvex.

4. The optical component of claim 2, wherein the partial reflector is flat.

5. The optical component of claim 2, wherein the cavity further comprises a pair of quarter-wave plates (QWPs) on opposite sides of the partial reflector.

6. The optical component of claim 1, wherein the partial reflector is a 50/50 reflector.

7. The optical component of claim 1, wherein the cavity comprises a pair of refractive optical elements on opposite sides of the partial reflector.

8. The optical component of claim 1, wherein the reflective polarizers are linear reflective polarizers.

9. The optical component of claim 1, wherein:
the cavity is substantially symmetrical and biconvex;
the partial reflector is flat; and
cavity further comprises a pair of quarter-wave plates (QWPs) on opposite sides of the partial reflector.

10. The optical component of claim 9, wherein:
the cavity comprises a pair of refractive optical elements on opposite sides of the partial reflector, each refractive optical element supporting one of the curved reflective polarizers on one side of the refractive optical element and one of the QWPs on the other side of the refractive optical element.

11. The optical component of claim 10, wherein the QWPs are supported by the partial reflector on opposite sides thereof.

12. The optical component of claim 1, further comprising a refractive optical element upstream of the cavity.

13. The optical component of claim 1, further comprising a refractive optical element downstream of the cavity.

14. A near-eye display (NED) comprising:
a display panel for providing an image in linear domain; and
an optical component for converting the image in linear domain into an image in angular domain at an eyebox of the NED, the optical component comprising:
a cavity formed by a pair of spaced apart coaxial curved reflective polarizers; and
a partial reflector in the cavity, for splitting an impinging light beam to propagate along two optical paths ending at ending at the eyebox, each optical path including a reflection from one of the reflective polarizers and a transmission through the other one of the reflective polarizers.

15. The NED of claim 14, wherein the cavity is substantially symmetrical, and wherein the partial reflector is equidistantly spaced from the reflective polarizers of the cavity.

16. The NED of claim 15, wherein the cavity is biconvex.

17. The NED of claim 15, wherein the partial reflector is flat.

18. The NED of claim 15, wherein the cavity further comprises a pair of quarter-wave plates (QWPs) on opposite sides of the partial reflector.

19. An offset-to-angle optical component comprising:
a substantially symmetrical cavity formed by a pair of spaced apart coaxial curved reflective polarizers; and
a 50/50 partial reflector in the middle of the cavity, separating the cavity into substantially identical first and second portions.

20. The offset-to-angle optical component of claim 19, wherein:
the reflective polarizers are linear reflective polarizers; and
each one of the first and second portions comprises a quarter-wave plate.
